(19) United States
(12) Patent Application Publication
(10) Pub. No.: US 2021/0040406 A1
(43) Pub. Date: Feb. 11, 2021

(54) DIVIDED SOUR NATURAL GAS TREATING SYSTEMS AND METHODS

(71) Applicant: Asset Risk Management, LLC, Houston, TX (US)

(72) Inventor: Brian L. Perilloux, Katy, TX (US)

(73) Assignee: Asset Risk Management, LLC, Houston, TX (US)

(21) Appl. No.: 16/932,387

(22) Filed: Jul. 17, 2020

Related U.S. Application Data
(60) Provisional application No. 62/876,558, filed on Jul. 19, 2019.

(51) Int. Cl. C10L 3/10; B01D 53/18; B01D 53/14

(52) U.S. Cl. CPC C10L 3/104; C10L 3/103; B01D 53/18; B01D 2252/204; B01D 53/1462; C10L 2290/541; C10L 2230/02; B01D 53/1425

(57) ABSTRACT

Divided sour gas treating systems and methods are described herein. In some embodiments, the systems include a plurality of absorbers proximate to respective ones of a plurality of sour natural gas sources and a regenerator which is remote from at least one of the plurality of absorbers.

### CROSS-REFERENCE TO RELATED APPLICATIONS

This application claims the benefit of priority to U.S. Provisional Application No. 62/876,558, filed Jul. 19, 2019, which is hereby incorporated herein by reference in its entirety.

### FIELD OF THE DISCLOSURE

This disclosure relates generally to natural gas treatment systems and methods, and more specifically to systems and methods for removing impurities from sour natural gas.

### BACKGROUND

Amine treating facilities are commonly used to treat or “sweeten” natural gas, such as that produced from wells by fracking. Often, natural gas emerges from wells as “sour” gas, containing impurities such as carbon dioxide (CO₂) and hydrogen sulfide (H₂S) which need to be removed in order for the natural gas to meet pipeline quality specifications, such as those for “Pipeline Natural Gas,” defined in 40 C.F.R. § 72.2, which is incorporated herein by reference in its entirety. To remove these impurities, one or more organic sweetening agents may be contacted with the sour gas to remove some volume of impurities to meet required specifications. For example, an amine, such as methyl-diethanolamine (MDEA), may be used as the sweetening agent.

Typically, sour natural gas is treated at a sour gas treating plant or station, which may include an absorber or contactor, a regenerator or still, and a means of disposing of acid gas, which may include a mixture of H₂S and/or CO₂. The sour gas treating plant or station is typically located on the same site as one or more natural gas wells. Because onshore oil and gas exploration and production sites often span vast acreages and because it is considered impractical to transport sour gas for long distances (i.e., distances greater than 1 mile or 1600 meters), a sour gas treating station is typically included at each and every central receiving point. Constructing, operating, and maintaining these separate sour gas treating stations is costly and time consuming.

Accordingly, improved systems and methods of treating natural gas are needed.

### SUMMARY

This summary is provided to introduce various concepts in a simplified form that are further described below in the detailed description. This summary is not intended to identify required or essential features of the claimed subject matter nor is the summary intended to limit the scope of the claimed subject matter.

In one aspect, a system for purifying sour natural gas is provided including: a plurality of absorbers remote from one another and located proximate to respective ones of a plurality of sour natural gas sources remote from one another, wherein each of the plurality of absorbers is configured to contact a lean amine stream with at least one of a plurality of respective sour natural gas streams from the plurality of respective sour natural gas sources to produce a plurality of respective rich amine streams and a plurality of respective sweet natural gas streams, each of the plurality of respective sour natural gas streams comprises natural gas and an impurity, and each of the plurality of rich amine streams comprises at least a portion of the impurity; and a regenerator configured to receive the plurality of rich amine stream from the plurality of absorbers, separate the rich amines into a purified amine and a waste stream, wherein the regenerator is remote from at least one of the plurality of absorbers, the impurity is present at a higher concentration in the plurality of rich amine streams than in the lean amine stream, the impurity is present at a higher concentration in the plurality sour natural gas streams than in the plurality of sweet natural gas streams, and the impurity is present at a higher concentration in the plurality of rich amine streams than in the purified amine stream.

In another aspect, a method of purifying sour natural gas is provided including: providing a plurality of sour natural gas streams remote from one another to a plurality of absorbers, each of the plurality of sour natural gas streams comprising natural gas and an impurity; contacting a lean amine stream with the plurality of sour natural gas streams in each of the plurality of absorbers to produce a plurality of respective rich amine streams comprising at least a portion of the impurity; and separating the plurality of rich amine streams in a regenerator to produce a purified amine stream and a waste stream, wherein the plurality of absorbers are each located proximate to respective ones of the plurality our natural gas sources, wherein the regenerator is remote from at least one of the plurality of absorbers, wherein the impurity is present at a higher concentration in the plurality of rich amine streams than in the lean amine stream, the impurity is present at a higher concentration in the plurality of sour natural gas streams than in the plurality of sweet natural gas streams, and the impurity is present at a higher concentration in the plurality of rich amine streams than in the purified amine stream.

This summary and the following detailed description provide examples and are explanatory only of the invention. Accordingly, the foregoing summary and the following detailed description should not be considered to be restrictive. Additional features or variations thereof can be provided in addition to those set forth herein, such as for example, various feature combinations and sub-combinations of these described in the detailed description.

### BRIEF DESCRIPTION OF THE DRAWINGS

The following figures form part of the present specification and are included to further demonstrate certain aspects of the present disclosure. The invention may be better understood by reference to one or more of these figures in combination with the detailed description of specific aspects presented herein.

FIG. 1 is a schematic illustration of a divided sour gas treatment system wherein a plurality of absorbers are arranged in series, but hydraulically connected in parallel, according to an embodiment of the present disclosure.

FIG. 2 is a schematic illustration of a divided sour gas treatment system wherein a plurality of absorbers are arranged in parallel radially around a regenerator, and hydraulically connected in parallel, according to an embodiment of the present disclosure.

FIG. 3 is a schematic illustration of an absorber according to an embodiment of the present disclosure.

FIG. 4 is a schematic illustration of a regenerator according to an embodiment of the present disclosure.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DETAILED DESCRIPTION

Divided methods and systems for treating sour natural gas are disclosed herein. In one aspect, a system for purifying sour natural gas is provided including: a plurality of absorbers remote from one another and located proximate to respective ones of a plurality of sour natural gas sources remote from one another, wherein each of the plurality of absorbers is configured to contact a lean amine stream with at least one of a plurality of respective sour natural gas streams from the plurality of respective sour natural gas sources to produce a plurality of respective rich amine streams and a plurality of respective sweet natural gas streams, each of the plurality of respective sour natural gas streams comprises natural gas and an impurity, and each of the plurality of rich amine streams comprises at least a portion of the impurity; and a regenerator configured to receive the plurality of rich amine stream from the plurality of absorbers, separate the rich amines into a purified amine and a waste stream, wherein the regenerator is remote from at least one of the plurality of absorbers, wherein the impurity is present at a higher concentration in the plurality of rich amine streams than in the lean amine stream, wherein the impurity is present at a higher concentration in the plurality sour natural gas streams than in the plurality of sweet natural gas streams, and wherein the impurity is present at a higher concentration in the plurality of rich amine streams than in the purified amine stream.

In another aspect, a method of purifying sour natural gas is provided including: providing a plurality of sour natural gas streams remote from one another to a plurality of absorbers, each of the plurality of sour natural gas streams comprising natural gas and an impurity; contacting a lean amine stream with the plurality of sour natural gas streams in each of the plurality of absorbers to produce a plurality of respective rich amine streams comprising at least a portion of the impurity; and separating the plurality of rich amine streams in a regenerator to produce a purified amine stream and a waste stream, wherein the plurality of absorbers are each located proximate to respective ones of the plurality of sour natural gas sources, wherein the regenerator is remote from at least one of the plurality of absorbers, wherein the impurity is present at a higher concentration in the plurality of rich amine streams than in the lean amine stream, wherein the impurity is present at a higher concentration in the plurality of sour natural gas streams than in the plurality of sweet natural gas streams, and wherein the impurity is present at a higher concentration in the plurality of rich amine streams than in the purified amine stream.

As used herein, an absorber or contactor refers to a piece of equipment designed to contact the sour natural gas and the lean amine. For example, in some embodiments, the absorber includes a column having a lower sour natural gas inlet and an upper lean amine inlet. In operation, the sour natural gas stream may be provided to the bottom of the column and the liquid lean amine stream may be provided to the top of the column. As the liquid lean amine falls down the length of the column (optionally passing through one or more internal mixing trays), it comes into contact with the sour natural gas, and the impurities are transferred from the sour natural gas to the amine. The column may further comprise an upper sweet natural gas outlet and a lower rich amine outlet.

As used herein, a regenerator or still refers to a piece of equipment designed to separate impurities from the rich amine. For example, the regenerator may be a distillation column designed to separate hydrogen sulfide and carbon dioxide from the rich amine. In some embodiments, the regenerator includes a column having an upper rich amine inlet, an upper waste stream outlet, and a lower lean amine outlet. In operation, the rich amine is provided near the top of the column, where it falls toward the bottom through a series of trays and is heated to separate the impurities into a waste stream, which rises upward through the series of trays, thereby promoting the release of impurities from the rich amine falling towards the bottom of the regenerator column.

As used herein, an absorber which is proximate to a sour natural gas source refers to an absorber which is less than about 3200 meters from a sour natural gas source, for example about 3100 meters, about 3000 meters, about 2900 meters, about 2800 meters, about 2700 meters, about 2600 meters, about 2500 meters, about 2400 meters, about 2300 meters, about 2200 meters, about 2100 meters, about 2000 meters, about 1900 meters, about 1800 meters, about 1700 meters, about 1600 meters, about 1500 meters, about 1400 meters, about 1300 meters, about 1200 meters, about 1100 meters, about 1000 meters, about 900 meters, about 800 meters, about 700 meters, about 600 meters, about 500 meters, about 400 meters, about 300 meters, about 200 meters, about 160 meters, about 150 meters or any ranges therebetween. As used herein, the distance from the sour natural gas source to the absorber refers to the distance along the surface of the Earth, such as in a pipeline, between the surface level exit from the sour natural gas source and the inlet to the absorber. That is, the distance between the sour natural gas source to the absorber does not include any underground distance within wells.

As used herein, sour natural gas sources which are remote from one another refer to sour natural gas sources which are at least about 1 mile (1600 meters) from one another. As used herein, the distance between sour natural gas sources refers to the distance along the surface of the Earth, such as in a pipeline, between the surface level exit from a first sour natural gas source and the surface level exit from a second sour natural gas source. That is, the distance between the sour natural gas sources does not include any underground distance within wells.

As used herein, a regenerator which is remote from at least one of the plurality of absorbers refers to a regenerator which is at least about 1 mile (1600 meters) from at least one of the plurality of absorbers. As used herein, the distance between a regenerator and an absorber refers to the distance along the surface of the Earth, or buried within about 10 feet from the surface of the Earth, such as in a pipeline, between the absorber outlet and the regenerator inlet.

In some embodiments, the system is a closed loop system, so that the purified amine stream from the regenerator is directly recycled to at least one or more of the plurality of absorbers as the lean amine stream. In some embodiments, additional lean amine may be added, so that both the purified amine stream and a fresh lean amine stream are contacted or mixed with one another at the outlet of the regenerator as the lean amine stream. A lean amine stream is associated with each of the plurality of absorbers, so that there are a plurality of respective lean amine streams. In some embodiments, the purified amine stream from the regenerator is directly recycled to each of the plurality of absorbers as respective lean amine streams.

In some embodiments, the amine includes a tertiary amine. For example, in some embodiments, the amine comprises methyl-diethanolamine (MDEA). In some embodiments, the amine comprises a secondary amine. For example, in some embodiments, the amine includes diethanolamine (DEA) or diisopropanolamine (DIPA). In some embodiments, the amine includes an amino alcohol. For example, in some embodiments, the amine includes ethanolamine (MEA) or aminoethoxyethanol (diglycolamine) (DGA).

In some embodiments, the impurity comprises one or more of carbon dioxide and hydrogen sulfide, and may further comprise mercaptans and carbonyl-sulfide (COS). In some embodiments, the waste stream is an acid gas stream. As used herein, an “acid gas stream” is used broadly to refer to a gas stream which, when combined with water, forms an acidic solution. For example, in some embodiments the waste stream includes one or more of carbon dioxide gas, hydrogen sulfide gas, mercaptans, and carbonyl sulfide.

Advantageously, in some embodiments the plurality of absorbers are each located less than about 1600 meters from a respective one of the plurality of sour natural gas sources, for example about 1600 meters from the sour natural gas source, about 1500 meters from the sour natural gas source, about 1400 meters from the sour natural gas source, about 1300 meters from the sour natural gas source, about 1200 meters from the sour natural gas source, about 1100 meters from the sour natural gas source, about 1000 meters from the sour natural gas source, about 900 meters from the sour natural gas source, about 800 meters from the sour natural gas source, about 700 meters from the sour natural gas source, about 600 meters from the sour natural gas source, about 500 meters from the sour natural gas source, about 400 meters from the sour natural gas source, about 300 meters from the sour natural gas source, about 200 meters from the sour natural gas source, about 160 meters from the sour natural gas source, or any ranges therebetween.

In some embodiments, the system includes a plurality of absorbers and a plurality of sour natural gas sources, but advantageously only includes a single regenerator. For example, in some embodiments the system includes two absorbers, three absorbers, four absorbers, five absorbers, ten absorbers, and so on. In some embodiments, the system includes a plurality of absorbers and a plurality of regenerators, with at least two absorbers feeding at least two rich amine streams to each regenerator.

As one of skill in the art would readily understand, often onshore oil and gas exploration and production producers have vast acreage locations for withdrawing sour natural gas, which can span 10 or more miles (16,000 or more meters), and often have multiple sour natural gas treating plants across their acreage proximate to the sour natural gas sources. It has typically been believed that locating the sour natural gas treating plants proximate to the sour natural gas sources is required, because sour natural gas presents a health and safety risk, such that its transport over long distance should be minimized. However, requiring a plurality of sour natural gas treating plants imposes significant additional cost, and delays due to regulatory approvals before new acid gas injection wells can be drilled in close proximity to oil and gas production wells. Specifically, regulatory approvals, such as air permits or acid gas injection well permits, are needed before waste streams and acid gas can be disposed of on the acreage. Advantageously, by separating the absorbers from a regenerator that services multiple absorbers, fewer regulatory approvals, and less capital expense, is required before drilling new oil and gas production wells. That is, new oil and gas production wells can be drilled and new absorbers installed and connected to the pre-existing centralized regenerator without having to transport the sour natural gas over increased distances, or having to apply for increased regulatory approvals. In some embodiments, the new oil and gas production wells can be drilled within at least 10 miles (16,000 meters) from the centralized regenerator.

Further, the systems described herein may advantageously reduce the risk of public exposure to sour gas and acid gas releases. For example, because the absorbers may be located proximate to the sour gas sources, they can be strategically located anywhere in the system, minimizing the length of any sour gas pipelines and their potential failure points. Similarly, by using a single regenerator, which is not proximate to the one or more absorbers, the risk of public exposure to acid gas may be reduced because acid gas will only be produced at the single regeneration facility. This single production point may advantageously allow for greater safety buffer zones, separating the public from potential unintentional acid gas releases at the regenerator or acid gas well injection sites. Moreover, more robust safety and operating controls may be able to be established at the regeneration facility than those possible using prior art systems. Specifically, operations personnel at the regenerator may be able to be limited to those with specialized training based on the specific operation of this single purpose-built facility. This may advantageously reduce the number of site flaring events, thereby reducing the cumulative acid gas emissions of the site.

Transporting lean and rich amines over these longer distances may require additional equipment, such as pumps and storage tanks. Accordingly, in some embodiments, the regenerator may be located a relatively small distance from the one or more absorbers. In some embodiments, the regenerator is located less than about 20 miles (32,000 meters) from the one or more absorbers, or less than about 10 miles (16,000 meters) from the one or more absorbers. For example, in some embodiments, the regenerator is located 20 miles from the one or more absorbers, 19 miles from the one or more absorbers, 18 miles from the one or more absorbers, 17 miles from the one or more absorbers, about 16 miles from the one or more absorbers, about 15 miles from the one or more absorbers, about 14 miles from the one or more absorbers, about 13 miles from the one or more absorbers, about 12 miles from the one or more absorbers, about 11 miles from the one or more absorbers, about 10 miles from the one or more absorbers, about 9 miles from the one or more absorbers, about 8 miles from the one or more absorbers, about 7 miles from the one or more absorbers, about 6 miles from the one or more absorbers, about 5 miles from the one or more absorbers, about 4 miles from the one or more absorbers, about 3 miles from the one or more absorbers, about 2 miles from the one or more absorbers, about 1 mile from the one or more absorbers, or any ranges therebetween.

In some embodiments, the system further includes a recycle system configured to recycle the purified amine to the lean amine stream. For example, in some embodiments, the system is a closed loop system, and the purified amine stream is recycled to at least one of the plurality of absorbers as the lean amine stream. In some embodiments, the system may further include a fresh lean amine stream, which is mixed with the purified amine stream to form the lean amine stream. A lean amine stream is associated with each of the plurality of absorbers so that there are a plurality of respective lean amine streams. In some embodiments, the purified amine stream from the regenerator is directly recycled to each of the plurality of absorbers as respective lean amine streams.

In some embodiments, the system further includes a disposal system configured to dispose of the waste stream. For example, in some embodiments, the disposal system includes a Claus sulfur recovery system. In some embodiments, the disposal system includes an acid gas injection well. In some embodiments, the disposal system includes a flare. In some embodiments, the disposal includes a thermal oxidizer.

In some embodiments, two or more of the plurality of absorbers are arranged in series and hydraulically connected in parallel. That is, in some embodiments, the lean amine stream travels from the regenerator to the two or more absorbers in series, and the rich amine stream travels from each of the two or more absorbers to the regenerator in series. In some embodiments, the two or more absorbers may be arranged in a linear corridor, such that the rich amine stream from each of the two or more absorbers travels from each of the respective two or more absorbers to the regenerator in the linear corridor.

In some embodiments, two or more of the plurality of absorbers are connected to the regenerator in parallel. That is, in some embodiments, the lean amine stream travels from the regenerator to the two or more absorbers as two or more lean amine streams in parallel, and the rich amine stream travels from each of the two or more absorbers as two or more rich amine streams in parallel. In some embodiments, the plurality of absorbers may be located radially around a centrally located regenerator.

### Illustrated Embodiments

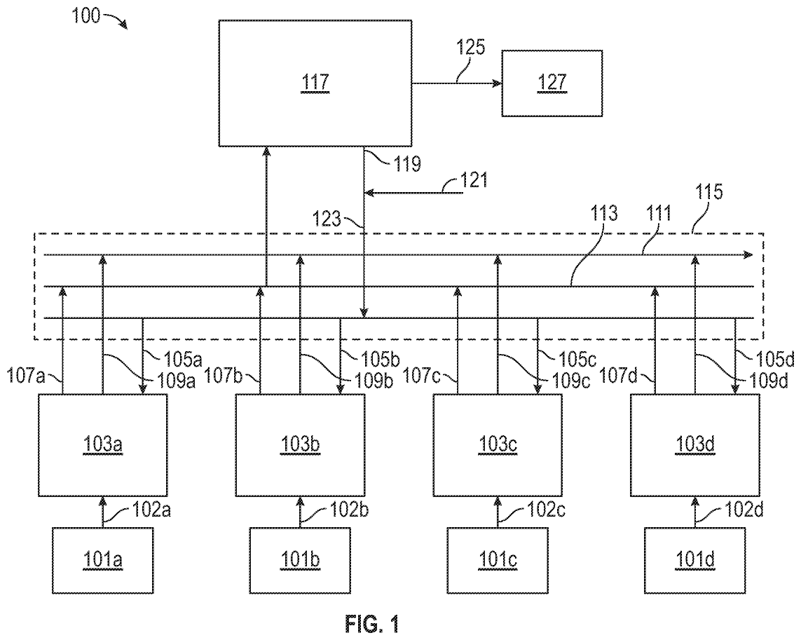

FIG. 1 is a schematic illustration of a divided sour gas treatment system 100 wherein a plurality of absorbers 103a, 103b, 103c, and 103d are arranged in series and hydraulically connected in parallel. Specifically, FIG. 1 illustrates four natural gas sources 101a, 101b, 101c, and 101d, which each produce a sour natural gas stream 102a, 102b, 102c, and 102d. Respective ones of the sour natural gas streams 102a, 102b, 102c, and 102d are each contacted with a plurality of lean amine streams 105a, 105b, 105c, and 105d in a respective plurality of absorbers 103a, 103b, 103c, and 103d to produce a respective plurality of rich amine streams 107a, 107b, 107c, and 107d and a plurality of respective sweetened natural gas streams 109a, 109b, 109c, and 109d. The sweetened natural gas streams 109a, 109b, 109c, and 109d may be combined in a single natural gas stream 111, which may pass through a pipeline to be distributed to consumers through traditional channels. The plurality of rich amine streams 107a, 107b, 107c, and 107d may be combined in a single rich amine stream 113, which may pass through a pipeline in the same pipeline right of way 115 as the natural gas stream 111.

Next, the single rich amine stream 113 is passed to a regenerator 117, which separates the rich amine stream 113 into a purified amine stream 119 and a waste stream 125. The purified amine stream 119 may be combined with a fresh amine stream 121 to produce a combined lean amine stream 123. The combined lean amine stream 123 may travel through a pipeline in the same pipeline right of way 115 as the natural gas stream 111 and the rich amine stream 113. The lean amine stream 123 is then divided into the four lean amine streams 105a, 105b, 105c, and 105d discussed above. The waste stream 125 may be provided to a waste disposal system 127.

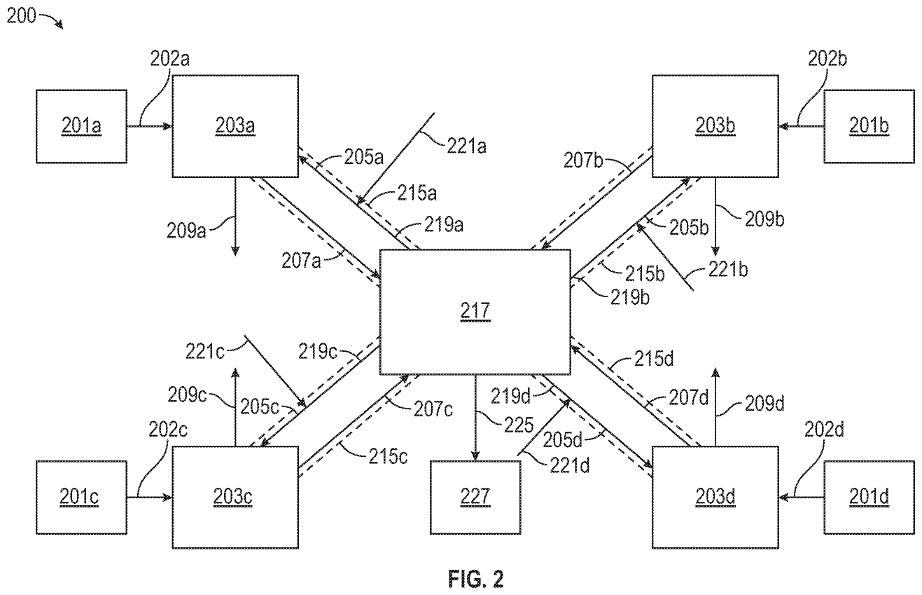

FIG. 2 is a schematic illustration of a divided sour gas treatment system 200 wherein a plurality of absorbers 203a, 203b, 203c, and 203d are arranged in parallel, radially around a regenerator 217, and are hydraulically connected in parallel. Specifically, FIG. 2 illustrates four natural gas sources 201a, 201b, 201c, and 201d, which each produce a sour natural gas stream 202a, 202b, 202c, and 202d. The plurality of sour natural gas streams 202a, 202b, 202c, and 202d are each contacted with respective ones of a plurality of lean amine streams 205a, 205b, 205c, and 205d in respective ones of a plurality of absorbers 203a, 203b, 203c, and 203d to produce a respective plurality of rich amine streams 207a, 207b, 207c, and 207d and a respective plurality of sweetened natural gas streams 209a, 209b, 209c, and 209d. The plurality of sweetened natural gas streams 209a, 209b, 209c, and 209d may be combined in a single natural gas stream (not shown), which may pass through a pipeline to be distributed to consumers through traditional channels. The plurality rich amine streams 207a, 207b, 207c, and 207d may be combined in a single rich amine stream (not shown), which may pass through a pipeline in the same pipeline right of way as the single natural gas stream (not shown).

Next, the plurality of rich amine streams 207a, 207b, 207c, and 207d are passed to a regenerator 217, which separates each of the rich amine streams 213a, 213b, 213c, and 213d into respective ones of a plurality of purified amine streams 219a, 219b, 219c, and 219d and a waste stream 225. The plurality of purified amine streams 219a, 219b, 219c, and 219d may be combined with respective ones of a plurality of fresh amine streams 221a, 221b, 221c, and 221d to produce the lean amine streams 205a, 205b, 205c, and 205d. The may travel through a pipeline in the pipeline right of way. The waste stream 225 may be provided to a waste disposal system 227.

Each of the purified amine streams 219a, 219b, 219c, and 219d and the fresh amine streams 221a, 221b, 221c, and 221d; lean amine streams 205a, 205b, 205c, and 205d; and the rich amine streams 207a, 207b, 207c, and 207d may pass between the absorbers and the regenerator 217 through pipeline rights of way 215a, 215b, 215c, and 215d.

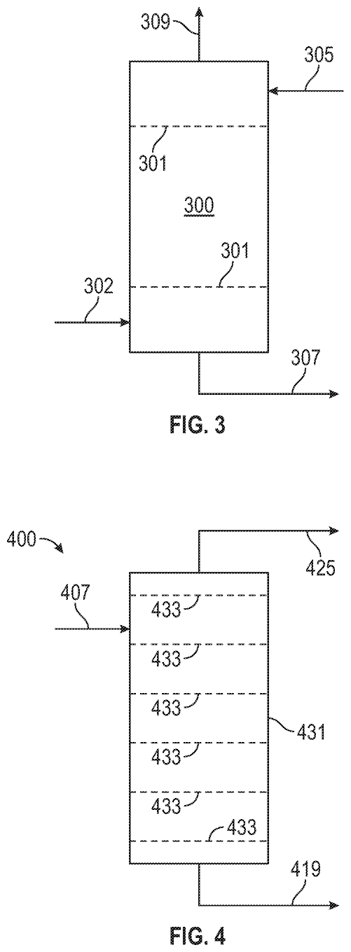

A schematic illustration of an absorber 300 is shown in FIG. 3. The absorber includes two internal mixing trays 301, and is provided with a sour natural gas stream 302 at a lower inlet and a lean amine stream 305 at an upper inlet. In some embodiments, the absorber may include a packed section in lieu of the internal mixing trays 301. In operation, the sour natural gas mixes with the liquid lean amine throughout the absorber 300, including at the internal mixing trays 301.

A schematic illustration of a regenerator 400 is shown in FIG. 4. The regenerator 400 includes a regeneration column 431 which receives a rich amine stream 407 at an upper inlet and produces a purified amine stream 419 and a waste stream 425. The regeneration column 431 includes a plurality of internal active trays 433. In some embodiments, portions of the purified amine stream 419 and the waste stream may be further recycled to the regenerator 400. In some embodiments, the regenerator 400 may further include a stripper column or tower, flash tank, lean/rich amine heat exchanger, amine heater or reboiler, filters, and other standard equipment which would be understood by one of skill in the art.

While the disclosure has been described with reference to a number of embodiments, it will be understood by those skilled in the art that the invention is not limited to such disclosed embodiments. Rather, the invention can be modified to incorporate any number of variations, alterations, substitutions, or equivalent arrangements not described herein, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A system for purifying sour natural gas comprising:
a plurality of absorbers remote from one another and located proximate to respective ones of a plurality of sour natural gas sources remote from one another, wherein each of the plurality of absorbers is configured to contact a lean amine stream with at least one of a plurality of respective sour natural gas streams from the plurality of respective sour natural gas sources to produce a plurality of respective rich amine streams and a plurality of respective sweet natural gas streams, each of the plurality of respective sour natural gas streams comprises natural gas and an impurity, and each of the plurality of rich amine streams comprises at least a portion of the impurity; and
a regenerator configured to receive the plurality of rich amine streams from the plurality of absorbers, separate the rich amine streams into a purified amine stream and a waste stream, wherein the regenerator is remote from at least one of the plurality of absorbers,
wherein the impurity is present at a higher concentration in the plurality of rich amine streams than in the lean amine stream, the impurity is present at a higher concentration in the plurality of sour natural gas streams than in the plurality of sweet natural gas streams, and the impurity is present at a higher concentration in the plurality of rich amine streams than the purified amine stream.

2. The system of claim 1, wherein the impurity comprises one or more of carbon dioxide and hydrogen sulfide.

3. The system of claim 1, wherein the waste stream is an acid gas stream.

4. The system of claim 3, wherein the acid gas stream comprises one or more of carbon dioxide and hydrogen sulfide.

5. The system of claim 1, wherein each of the plurality of absorbers are located less than about 1 mile from at least one of the plurality of sour natural gas sources.

6. The system of claim 1, wherein the regenerator is located less than about 20 miles from one or more of the plurality of absorbers.

7. The system of claim 1, wherein the regenerator is located less than about 10 miles from one or more of the plurality of absorbers.

8. The system of claim 1, further comprising:
a recycle system configured to recycle the purified amine stream to the lean amine stream of one or more of the plurality of absorbers.

9. The system of claim 1, further comprising:
a disposal system configured to dispose of the waste stream.

10. The system of claim 9, wherein the disposal system comprises a Claus sulfur recovery system.

11. The system of claim 9, wherein the disposal system comprises an acid gas injection well.

12. The system of claim 1, wherein at least two of the plurality of absorbers are connected to the regenerator, arranged in series but hydraulically connected in parallel.

13. The system of claim 1, wherein at least two of the plurality of absorbers are connected to the regenerator in parallel and are hydraulically connected in parallel.

14. The system of claim 13, wherein the regenerator is centrally located and the at least two of the plurality of absorbers are arranged radially around the regenerator.

15. A method of purifying sour natural gas comprising:
providing a plurality of sour natural gas streams from a respective plurality of sour natural gas sources remote from one another to a plurality of absorbers, each of the plurality of sour natural gas streams comprising natural gas and an impurity;
contacting a lean amine stream with each of the plurality of sour natural gas streams in each of the plurality of absorbers to produce a plurality of respective rich amine streams and a respective plurality of sweet natural gas streams, each of the plurality of rich amine streams comprising at least a portion of the impurity; and
separating the plurality of rich amine streams in a regenerator to produce a purified amine stream and a waste stream,
wherein each of the plurality sour natural gas streams comprises natural gas and an impurity, the plurality of absorbers are each located proximate to respective ones of the plurality of sour natural gas sources, the regenerator is remote from at least one of the plurality of absorbers, the impurity is present at a higher concentration in the plurality of rich amines than in the lean amine stream, the impurity is present at a higher concentration in the plurality of sour natural gas streams than in the plurality of sweet natural gas streams, and the impurity is present at a higher concentration in the plurality of rich amine streams than in the purified amine streams.

16. The method of claim 15, wherein the impurity comprises one or more of carbon dioxide and hydrogen sulfide.

17. The method of claim 15, wherein the waste stream is an acid gas stream.

18. The method of claim 17, wherein the acid gas stream comprises one or more of carbon dioxide and hydrogen sulfide.

19. The method of claim 15, wherein each of the plurality of absorbers are located less than about 1 mile from at least one of the plurality of sour natural gas sources.

20. The method of claim 15, wherein the regenerator is located less than about 20 miles from the one or more absorbers.

21. The method of claim 15, wherein the regenerator is located less than about 10 miles from the plurality of absorbers.

22. The method of claim 15, further comprising:
recycling the purified amine stream to the lean amine stream of one or more of the plurality of absorbers.

23. The method of claim 15, further comprising:
disposing of the waste stream using a disposal system.

24. The method of claim 23, wherein the disposal system comprises a Claus sulfur recovery system.

25. The method of claim 23, wherein the disposal system comprises an acid gas injection well.

26. The method of claim 15, wherein at least two of the plurality of absorbers are connected to the regenerator in series.

27. The method of claim 15, wherein at least two of the plurality of absorbers are connected to the regenerator in parallel.
